(19) United States
(12) Patent Application Publication
(10) Pub. No.: US 2024/0073170 A1
(43) Pub. Date: Feb. 29, 2024

(54) METHOD FOR DETERMINING COGNITIVE LOAD-DRIVEN CONCURRENCY LIMITS BASED ON TEXT COMPLEXITY

(71) Applicant: NICE LTD, Ra'anana (IL)

(72) Inventors: Nick MARTIN, Plano, TX (US); Kalyani CHENNUPATI, Coppell, TX (US); Jin TANG, Carrollton, TX (US)

(21) Appl. No.: 17/899,227

(22) Filed: Aug. 30, 2022

(51) Int. Cl. H04L 51/214; G06F 40/40; G06Q 10/06

(52) U.S. Cl. CPC H04L 51/214; G06F 40/40; G06Q 10/063112

(57) ABSTRACT

A workforce management system and methods for managing a workload of an agent include receiving a first written interaction from a first customer; routing the first written interaction to an agent; determining a readability score of the first written interaction; aggregating the readability score with a plurality of past readability scores of written interactions assigned to the agent; creating a readability score scale based on the aggregated readability score with the plurality of past readability scores; creating a concurrency level scale based on a minimum concurrency level and a maximum concurrency level of the agent; correlating readability scores and concurrency levels using the readability score scale and the concurrency level scale; and adjusting the maximum concurrency level of the agent based on the correlation.

### TECHNICAL FIELD

The present disclosure relates generally to determining cognitive load of an agent handling simultaneous written customer interactions, and more specifically to systems and methods for limiting the concurrent workload of an agent.

### BACKGROUND

Contact centers (also referred to as call centers herein) are experiencing a substantial increase in consumer interactions with text-based, written modes of communication such as chat, email, text, or social media/web postings. Given that more and more contact volume within the contact center is text-based, a given agent's reading comprehension becomes increasingly important to timely handle customer requests and to meet service goals. The degree of difficulty of a written communication can greatly affect the comprehension ability of an agent.

Written interactions that are easier to read place less cognitive load on an agent to comprehend, while more difficult interactions require greater cognitive load. These written modes of communication can provide contact centers significant staffing efficiency gains since a single agent can handle multiple written interactions simultaneously or concurrently, rather than having just one agent handle each interaction separately.

The problem for workforce managers and supervisors is they lack a method to evaluate the cognitive load placed on an agent to determine a limit to the number of simultaneous interactions that are appropriate to handle. An added complication is that workforce managers and supervisors want their agents to have a sufficient level of work to keep them engaged. Too little work volume or too much work volume can negatively affect agent morale and both scenarios can prevent optimal performance.

In the context of handling simultaneous written interactions, an agent handling multiple written interactions can have improved performance until the difficulty becomes too great. At such point, the agent will become overwhelmed and may experience difficulty in some or all of: perceiving messages (i.e., missing responses from customers), understanding (i.e., comprehending the information a customer is conveying to the agent), or action (i.e., determining the course of action to resolve a customer's need).

Contact centers lack a method to assess and limit the cognitive load of text-based customer interactions for a given agent, which prevents contact centers from determining an optimal number of simultaneous text-based interactions an agent can handle. Accordingly, a need exists for systems and methods for improved, more accurate and efficient methods for determining the maximum number of written interactions an agent can handle concurrently.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a contact center according to various aspects of the present disclosure.

FIG. 2 is a more detailed block diagram of the contact center of FIG. 1 according to aspects of the present disclosure.

FIG. 3 is an exemplary computing environment suitable for implementing the present methods and systems, according to aspects of the present disclosure.

FIG. 4 is a flowchart of a method according to embodiments of the present disclosure.

FIG. 5 is a block diagram of a computer system suitable for implementing one or more components in FIG. 1, 2, or 3 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein provide a tool to assess customer written communications for readability in a quantifiable manner to determine cognitive load and offer a mechanism to apply such assessments to limit the concurrent workload for a given agent or employee. In one or more embodiments, for every written interaction (e.g., chat, email, text, or social media/web posting), the written information from a customer is evaluated for text complexity. In some embodiments, the customer text is scanned and a readability score is calculated using a combination of the Flesch reading ease score and a natural language processing algorithm. In various embodiments, the readability score is used to route the written interaction to a suitable agent and to determine the effects the score has on the cognitive load of the agent. In some embodiments, the mean concurrency values for the agent can be derived over time and applied. In an exemplary embodiment, the agent's concurrency limit is adjusted proportionally to the difficulty of the written interaction.

Optionally, the readability score of the written interaction may be used to route the interaction to an agent with proportionate reading complexity/comprehension ability. For example, a customer who starts a chat that is written at the collegiate level will be routed to an agent (who can have been similarly evaluated) who also writes at a corresponding level. In various embodiments, when routed to an agent, the customer's readability score is aggregated with past readability scores of interactions assigned to the agent, and the mathematical mean and standard deviation of the readability score is calculated. The mean readability score is then correlated with the mean concurrency level. In certain embodiments, an initial mean concurrency level can be determined by assessing a test set of the agent's readability scores. In another embodiment, the readability score of the written interaction may be used to route the interaction to an agent who has not reached their concurrency limit based on their current workload.

In several embodiments, readability scores are inversely correlated to concurrency levels based on standard deviations from the mean. For example, a readability score that is 1× standard deviation from the mean will result in a concurrency adjustment of −1× standard deviation from the mean. A readability score that is 3× standard deviation from the mean will result in a concurrency adjustment of −3× standard deviation from the mean. In various embodiments, the readability score is added to the historical record that maintains all scores to be used for comparison in the next customer response.

Cognitive psychology describes the issue of optimal performance with the Yerkes-Dodson Law, which states that an individual's performance for a given task will increase as stress (or pressure) is applied, but that performance will only increase to a point. Applied to chats and other text-based communications, an agent would be expected to handle more written interactions if the written interactions are easier to read. An individual will increase cognitive resources such as attention and interest as tasks become increasingly difficult. Once the stress of a task becomes too great, however, an individual's performance will decrease, sometimes substantially. Common impaired performance effects can include one or more of cognitive tunnelling (overly-focused on certain messages/interactions), decreased memory and recall functions, and reduced problem-solving skills.

Workforce management (WFM) is an integrated set of processes that a company may use to optimize the productivity of its employees. For example, WFM includes applications that enable contact center management to forecast workloads and align staffing needs around those forecasts. WFM involves effectively forecasting labor requirements and creating and managing staff schedules to accomplish a particular task on a day-to-day and hour-to-hour basis.

Current WFM solutions, however, do not assess customer written interactions for readability (and thus assess cognitive load) or provide a mechanism to apply such assessments to limit workloads (e.g., chat concurrency). WFM practices are typically concerned with agent burn-out, but generally only address back-to-back customer interaction handling and without consideration for simultaneous interactions. No current WFM tool currently helps users measure and apply cognitive load limits to session handling.

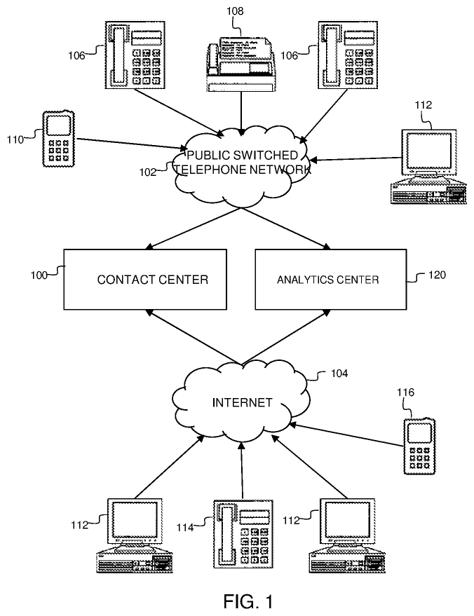

FIG. 1 is a simplified block diagram of an embodiment of a contact center 100 according to various aspects of the present disclosure. The term “contact center,” as used herein, can include any facility or system server suitable for receiving and recording electronic communications from contacts. Such contact communications can include, for example, telephone calls, facsimile transmissions, e-mails, web interactions, voice over IP (“VoIP”) and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. In some embodiments, the communications can include contact tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 100 of the present disclosure is adapted to receive and record varying electronic communications and data formats that represent an interaction that may occur between a contact (or customer) and a contact center agent during fulfillment of a contact and agent transaction. In one embodiment, the contact center 100 records all of the contact calls in uncompressed audio formats. In the illustrated embodiment, contacts may communicate with agents associated with the contact center 100 via multiple different communication networks such as a public switched telephone network (PSTN) 102 or the Internet 104. For example, a contact may initiate an interaction session through traditional telephones 106, a fax machine 108, a cellular (i.e., mobile) telephone 110, a personal computing device 112 with a modem, or other legacy communication device via the PSTN 102. Further, the contact center 100 may accept internet-based interaction sessions from personal computing devices 112, VoIP telephones 114, and internet-enabled smartphones 116 and personal digital assistants (PDAs).

Often, in contact center environments such as contact center 100, it is desirable to facilitate routing of contact communications, particularly based on agent availability, prediction of profile (e.g., personality type) of the contact occurring in association with a contact interaction, and/or matching of contact attributes to agent attributes (such as similar reading/writing comprehension skills), be it a telephone-based interaction, a web-based interaction, a text-based interaction, or other type of electronic interaction over the PSTN 102 or Internet 104.

As one of ordinary skill in the art would recognize, the illustrated example of communication channels associated with a contact center 100 in FIG. 1 is just an example, and the contact center may accept contact interactions, and other analyzed interaction information and/or routing recommendations from an analytics center, through various additional and/or different devices and communication channels whether or not expressly described herein.

For example, in some embodiments, internet-based interactions and/or telephone-based interactions may be routed through an analytics center 120 before reaching the contact center 100 or may be routed simultaneously to the contact center and the analytics center (or even directly and only to the contact center). Also, in some embodiments, internet-based interactions may be received and handled by a marketing department associated with either the contact center 100 or analytics center 120. The analytics center 120 may be controlled by the same entity or a different entity than the contact center 100. Further, the analytics center 120 may be a part of, or independent of, the contact center 100.

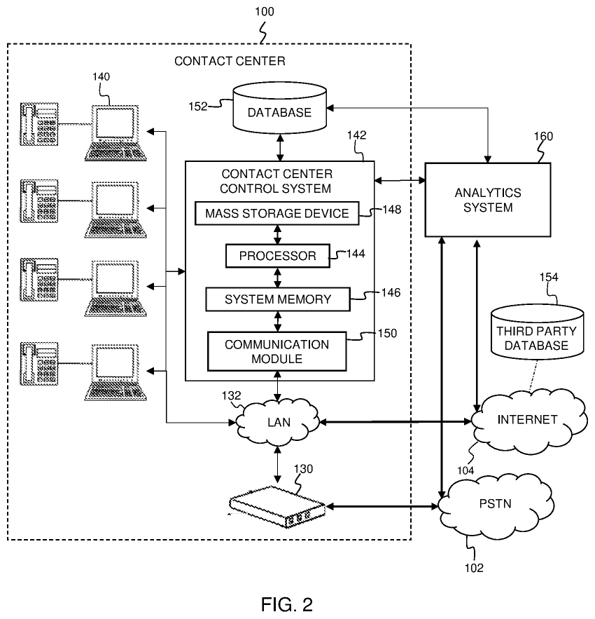

FIG. 2 is a more detailed block diagram of an embodiment of the contact center 100 according to aspects of the present disclosure. As shown in FIG. 2, the contact center 100 is communicatively coupled to the PSTN 102 via a distributed private branch exchange (PBX) switch 130 and/or automatic communication distributor (ACD) 130. ACDs are specialized systems that are configured to match contact communications (also referred to herein as interactions) to an available contact center agent. ACDs generally receive incoming communications, determine where to route a particular contact communication, and connect the contact communication to an available agent. For the purposes of the present disclosure, “ACD” refers to any combination of hardware, software and/or embedded logic that is operable to automatically distribute incoming communications, including requests for service transmitted using any audio and/or video means, including signals, data or messages transmitted through voice devices, text chat, web sessions, facsimile, instant messaging and e-mail.

ACD 130 distributes contact communications or tasks to agents. Generally, ACD 130 is part of a switching system designed to receive contact communications and queue them. In addition, ACD 130 as shown distributes communications to agents or specific groups of agents typically according to a prearranged scheme. In one embodiment, ACD 130 is integrated with PBX switch 130, and directs contact communications to one of a plurality of agent workstations 140.

According to an exemplary embodiment, ACD 130 includes a processor, a network interface, and a memory module or database. The network interface joins ACD 130 with a local area network (LAN 132). Once ACD 130 receives a contact communication, the processor determines which of a plurality of agents should receive the communication. For example, the processor may access the memory module, which stores code executed by the processor to perform various tasks.

In various embodiments, the processor includes a plurality of engines or modules. Examples of suitable engines include a distributor engine, a queue engine, and a monitor engine. The distributor engine distributes incoming contact communications to available agents, the queue engine monitors and maintains contact communications that are waiting to be connected to agents, and the monitor engine checks the status and skills of agents and stores appropriate information in the memory module.

The memory module stores various information about agents at the contact center, including, but not limited to, agent skills or attributes, agent location, and agent availability. Various alternative embodiments of ACD 130 may store different or additional information useful for communication routing as well. Over time, monitor engine updates agent skills information, location information, and availability based on changes in agent status detected.

Generally, ACD 130 receives incoming communications that may be handled by one of the agents at the contact center. The distributor engine connects the communication to an appropriate available agent if the agent is available. If the agent is not available, the communication is generally held by the queue engine until the agent becomes available. While a contact is waiting for an agent, ACD 130 may collect data from the contact or perform other automated processes. Once the agent is available, the distributor engine routes the communication to the agent.

In an exemplary embodiment, ACD 130 is configured to perform attribute-based routing, which refers to routing incoming communications based on matching the attributes of the contact and the attributes of the agents. This ensures that communications go to agents with the correct attributes to ensure a better contact experience. Attribute-based routing considers the unique skills of individual agents and the preferences of individual contacts to route contact communications to the most qualified or most appropriate agent.

The contact center 100 is further communicatively coupled to the Internet 104 via hardware and software components within the LAN 132. One of ordinary skill in the art would recognize that the LAN 132 and the connections between the contact center 100 and external networks such as the PSTN 102 and the Internet 104 as illustrated by FIG. 2 have been simplified for the sake of clarity and the contact center may include various additional and/or different software and hardware networking components such as routers, switches, gateways, network bridges, hubs, and legacy telephony equipment.

As shown in FIG. 2, the contact center 100 includes a plurality of agent workstations 140 that enable agents employed by the contact center 100 to engage in contact interactions over a plurality of communication channels. In one embodiment, each agent workstation 140 may include at least a telephone and a computer workstation. In other embodiments, each agent workstation 140 may include a computer workstation that provides both computing and telephony functionality. Through the workstations 140, the agents may engage in telephone conversations with the customer, respond to email inquiries, receive faxes, engage in instant message conversations, text (e.g., SMS, MMS), respond to website-based inquires, video chat with a customer, and otherwise participate in various customer interaction sessions across one or more channels including social media postings (e.g., Facebook, LinkedIn, etc.). Further, in some embodiments, the agent workstations 140 may be remotely located from the contact center 100, for example, in another city, state, or country. Alternatively, in some embodiments, an agent may be a software-based application configured to interact in some manner with a customer. An exemplary software-based application as an agent is an online chat program designed to interpret customer inquiries and respond with pre-programmed answers.

The contact center 100 further includes a contact center control system 142 that is generally configured to provide recording, voice analysis, behavioral analysis, text analysis, storage, and other processing functionality to the contact center 100. In the illustrated embodiment, the contact center control system 142 is an information handling system such as a computer, server, workstation, mainframe computer, or other suitable computing device. In other embodiments, the control system 142 may be a plurality of communicatively coupled computing devices coordinated to provide the above functionality for the contact center 100. The control system 142 includes a processor 144 that is communicatively coupled to a system memory 146, a mass storage device 148, and a communication module 150. The processor 144 can be any custom made or commercially available processor, a central processing unit (CPU), an auxiliary processor among several processors associated with the control system 142, a semiconductor-based microprocessor (in the form of a microchip or chip set), a macroprocessor, a collection of communicatively coupled processors, or any device for executing software instructions. The system memory 146 provides the processor 144 with non-transitory, computer-readable storage to facilitate execution of computer instructions by the processor. Examples of system memory may include random access memory (RAM) devices such as dynamic RAM (DRAM), synchronous DRAM (SDRAM), solid state memory devices, and/or a variety of other memory devices known in the art. Computer programs, instructions, and data, such as known voice prints, may be stored on the mass storage device 148. Examples of mass storage devices may include hard discs, optical disks, magneto-optical discs, solid-state storage devices, tape drives, CD-ROM drives, and/or a variety other mass storage devices known in the art. Further, the mass storage device may be implemented across one or more network-based storage systems, such as a storage area network (SAN). The communication module 150 is operable to receive and transmit contact center-related data between local and remote networked systems and communicate information such as customer interaction recordings between the other components coupled to the LAN 132. Examples of communication modules may include Ethernet cards, 802.11 WiFi devices, cellular data radios, and/or other suitable devices known in the art. The contact center control system 142 may further include any number of additional components, which are omitted for simplicity, such as input and/or output (I/O) devices (or peripherals), buses, dedicated graphics controllers, storage controllers, buffers (caches), and drivers. Further, functionality described in association with the control system 142 may be implemented in software (e.g., computer instructions), hardware (e.g., discrete logic circuits, application specific integrated circuit (ASIC) gates, programmable gate arrays, field programmable gate arrays (FPGAs), etc.), or a combination of hardware and software.

According to one aspect of the present disclosure, the contact center control system 142 is configured to record, collect, and analyze contact voice data and other structured and unstructured data, and other tools may be used in association therewith to increase efficiency and efficacy of the contact center. As an aspect of this, the control system 142 is operable to record unstructured interactions between contacts and agents occurring over different communication channels including without limitation telephone conversations, email exchanges, website postings, social media communications, smartphone application (i.e., app) communications, fax messages, texts (e.g., SMS, MMS, etc.), and instant message conversations.

In one embodiment, multiple communication channels (i.e., multi-channel) may be used, either in real-time to collect information, for evaluation, or both. For example, control system 142 can receive, evaluate, and store telephone calls, emails, and fax messages. Thus, multi-channel can refer to multiple channels of interaction data, or analysis using two or more channels, depending on the context herein.

The control system 142 may store recorded and collected interaction data in a database 152, including contact data and agent data. In certain embodiments, agent data, such as agent scores for dealing with contacts, are updated daily.

The control system 142 may store recorded and collected interaction data in a database 152. The database 152 may be any type of reliable storage solution such as a RAID-based storage server, an array of hard disks, a storage area network of interconnected storage devices, an array of tape drives, or some other scalable storage solution located either within the contact center or remotely located (i.e., in the cloud). Further, in other embodiments, the contact center control system 142 may have access not only to data collected within the contact center 100 but also data made available by external sources such as a third party database 154. In certain embodiments, the control system 142 may query the third party database for contact data such as credit reports, past transaction data, and other structured and unstructured data.

Additionally, in some embodiments, an analytics system 160 may also perform some or all of the functionality ascribed to the contact center control system 142 above. For instance, the analytics system 160 may record telephone and internet-based interactions, and/or perform behavioral analyses. The analytics system 160 may be integrated into the contact center control system 142 as a hardware or software module and share its computing resources 144, 146, 148, and 150, or it may be a separate computing system housed, for example, in the analytics center 120 shown in FIG. 1. In the latter case, the analytics system 160 includes its own processor and non-transitory computer-readable storage medium (e.g., system memory, hard drive, etc.) on which to store analytics software and other software instructions.

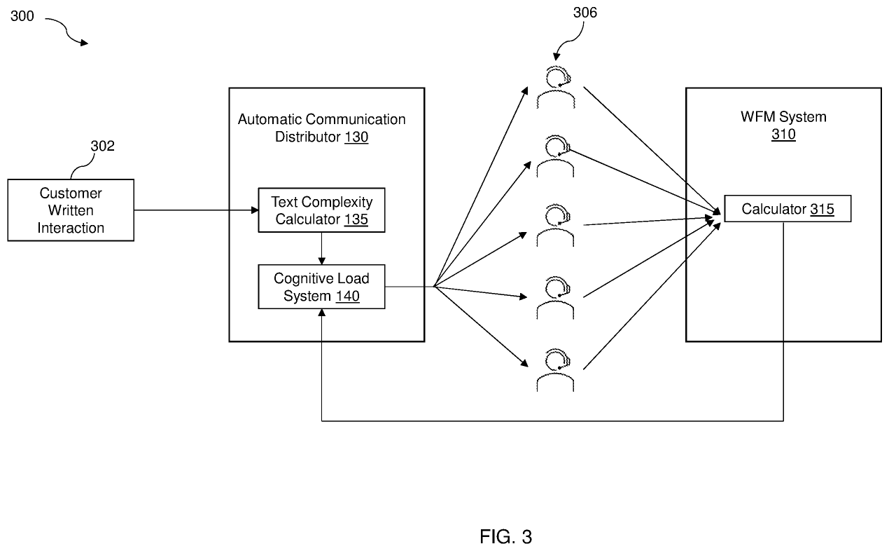

Referring now to FIG. 3, shown is an exemplary computing environment 300 where the present methods and systems may be implemented. The environment 300 includes ACD 130 and WFM system 310. In this embodiment, ACD 130 includes a text complexity calculator 135 and cognitive load system 140, and WFM system 310 includes calculator 315.

Regardless of digital channel, a customer interaction according to the present disclosure begins with a customer creating a “chat” or a written interaction 302. As used herein, “written interaction” refers to any agent and customer interaction that is text-based in nature, including communication channels such as chat, short message service (SMS) or similar texting, email, messaging applications (e.g., Facebook messenger, Twitter direct messages, or WhatsApp), social media (e.g., Facebook, Twitter, or Instagram), collaborative messaging applications (e.g., Microsoft Teams or Slack), and social monitoring platforms (e.g., Amazon reviews or Google Play reviews).

This initial written interaction 302 is read by the text complexity calculator 135 to determine the readability score and is aggregated into the system cognitive load values stored in cognitive load system 140. In an exemplary embodiment, text complexity calculator 135 determines the readability score from a combination of the Flesch reading ease formula and any suitable natural language processing algorithm.

The output (i.e., the readability score) of text complexity calculator 135 and the system cognitive load values are used by calculator 315 to compute the mean readability score and the mean concurrency level of an agent 306. Calculator 315 also recalculates mathematical mean and standard deviation readability scores and concurrency values. With each classification and computation, the training model can improve the accuracy of the concurrency value.

In certain embodiments, the mean concurrency level is in part derived from the system cognitive load values, which defines the maximum number of concurrent sessions or the concurrency limit of an agent 306. In various embodiments, calculator 315 recalculates concurrency limits of each agent 306, and provides these recalculated concurrency limits to cognitive load system 140. ACD 130 can use these limits in combination with the readability score of an incoming written interaction to determine which agent should be assigned to the incoming written interaction.

In one or more embodiments, WFM system 310 stores a mean concurrency level for the contact type that each agent can handle. For example, agent 1 can handle up to a maximum of two written interactions at one time, and agent 2 can handle up to a maximum of three written interactions at one time, based on an average readability score of the written interaction.

In various embodiments, cognitive load system 140 also keeps track of the current load on each agent 306 and the readability score for each interaction. For example, agent 1 may be currently handling one written interaction with a readability score of 60, and agent 2 may be handling two written interactions, one with a readability score of 50 and another with a readability score of 60. These system cognitive load values are used to decide to which agent 306 the written interaction 302 should be routed.

In certain embodiments, ACD 130 routes to an available agent who is not yet at his/her cognitive load limit. For example, if the maximum cognitive load limit (or maximum concurrency limit) of an agent is 5, and the current load of the agent is 4, ACD 130 can route an interaction to that agent if it will not result in exceeding the maximum cognitive load limit. From this point, every new written interaction from a customer is processed for readability scores by text complexity calculator 135. Changes in the readability score calculated by text complexity calculator 135 automatically update the readability scales first and the cognitive load or concurrency level scale secondly, as discussed in further detail below.

In various embodiments, WFM system 310 includes a user interface that displays concurrency or cognitive load limits on digital channels. These values may be user-defined. Advantageously, the present methods and systems provide an automated process to calculate and enter the values into these fields. Additionally, as the text readability process is dynamic and as the cognitive load limit scales are updated, the values within these fields are automatically updated. In one or more embodiments, users retain the ability to manually overwrite entered values. The users authorized to do so may be adjusted as applicable, e.g., only a supervisor or manager may be provided the ability to manually overwrite values.

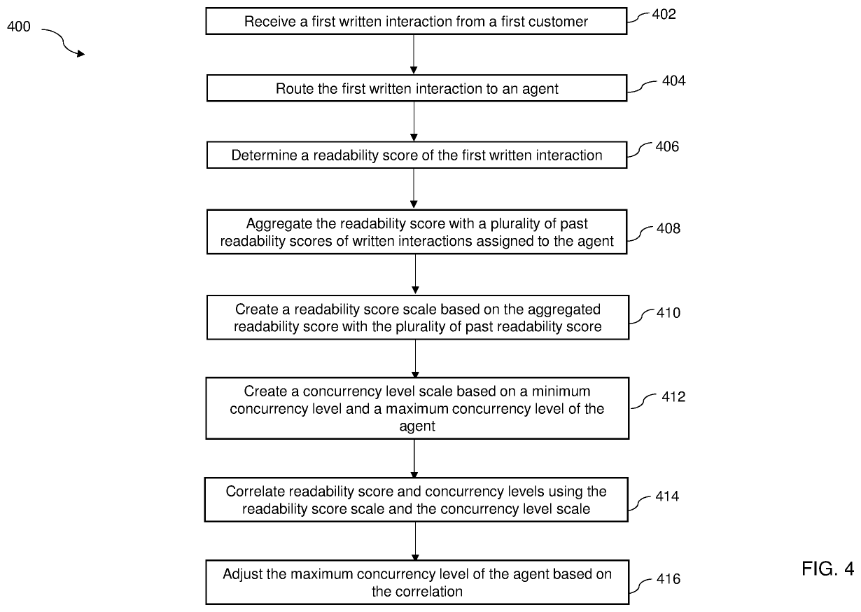

Referring now to FIG. 4, a method 400 according to embodiments of the present disclosure is described. At step 402, ACD 130 receives a first written interaction 302 from a first customer. The written interaction 302 may be any written communication such as an email, text, message, or post.

At step 404, ACD 130 routes the first written interaction 302 to an agent 306. Optionally, ACD 130 determines a reading comprehension level of the agent 306, and before routing the first written interaction to the agent 306, determines whether the agent 306 is capable of handling the first written interaction 302 based on the readability score of the first written interaction 302 and the reading comprehension level of the agent 306.

At step 406, ACD 130 via text complexity calculator 135 determines a readability score of the first written interaction 302. In various embodiments, the first written interaction is scanned into text complexity calculator 135. In certain embodiments, determining the readability score includes calculating a Flesch reading ease score of the first written interaction 302, classifying text of the first written interaction into a numeric class using a natural language processing algorithm, and multiplying the Flesch reading ease score and the numeric class to provide the readability score of the first written interaction 302. The easier the text, the higher the readability score assigned.

Each written interaction from a customer consists of a different length of words. The Flesch reading ease score helps determine the fundamental complexity of the text. The Flesch reading ease score is calculated from the following formula:

$$Flesh reading ease score = 206. 8 \; 35 ‐ 1.015 ( \frac{total words}{total sentences} ) - 84.6 ( \frac{total syllables}{total words} )$$

(see https://readabilityformulas.com/flesch-reading-ease-readability-formula.php).

In one embodiment, the natural language processing algorithm is the Multinomial Naive Bayes algorithm. The Multinomial Naive Bayes algorithm is a probabilistic learning method that is mostly used in artificial intelligence-based natural language processing. The algorithm is based on the Bayes theorem and predicts the classification of text by calculating the probability of each classification for each sample, and then gives the classification with the highest probability as the output. The Multinomial Naive Bayes algorithm classifies the customer text or words based on the difficulty. The output of the Multinomial Naive Bayes algorithm is typically a numeric percentage, but can also be a numeric class. Advantageously, the product of the Flesch reading ease score and the output of the Multinomial Naive Bayes algorithm achieves a better text input complexity and classification result compared to using each algorithm separately.

At step 408, ACD 130 aggregates the readability score with a plurality of past readability scores of written interactions assigned to the agent 306. In other words, the readability score of the first written interaction is added to a compilation of readability scores for the agent 306.

At step 410, WFM system 310 via calculator 315 creates a readability score scale based on the aggregated readability score with the plurality of past readability scores. In various embodiments, creating the readability score scale includes calculating a mean readability score and one standard deviation from the mean readability score based on the aggregated readability score with the plurality of past readability scores. In other embodiments, creating the readability score further includes calculating two and three standard deviations of the readability score from the mean readability score.

At step 412, WFM system 310 via calculator 315 creates a concurrency level scale based on a minimum concurrency level and a maximum concurrency level of the agent 306. In one or more embodiments, WFM system 310 determines the minimum concurrency level and the maximum concurrency level of the agent 306. For example, concurrency levels can be determined by assessing a test set of the agent's readability scores. In several embodiments, creating the concurrency level scale includes calculating a mean concurrency level and one standard deviation from the mean concurrency level based on the minimum concurrency level and the maximum concurrency level. In some embodiments, creating the concurrency level scale further includes calculating two and three standard deviations of the concurrency level from the mean concurrency level.

Calculation of concurrency limits is achieved by creating the two scales. One scale is the level of concurrency, and the other is a corresponding scale to determine readability levels.

The concurrency level scale is determined using a uniform distribution. In such distributions, the mathematical mean (μ) is calculated using the equation

$$μ = \frac{a + b}{2}$$

where a and b are defined maximum and minimum limits configured by the user. Additionally, the Standard Deviation (σ) is calculated using the equation

$$σ = \frac{b - a}{\sqrt{12}}$$

where a and b are defined maximum and minimum limits configured by the user. The concurrency level scale is created with the mean and the corresponding standard deviations.

The readability score scale is dynamically created based on the total population of readability scores for a given agent. This scale is continually and automatically adjusted as new readability scores are added to the population. This is based on a normal distribution calculation for μ and σ which is

$$\sqrt{\frac{\sum {( {x}_{i} - μ )}^{2}}{N}} .$$

The readability score scale is constructed with the mean and corresponding standard deviations in a similar fashion as with the concurrency values.

At step 414, WFM system 310 correlates readability scores and concurrency levels using the readability score scale and the concurrency level scale. In an exemplary embodiment, WFM system 310 calculates the concurrency limit (or the maximum concurrency level) based on a configured multiple of standard deviations from the mean of the readability scores.

At step 416, ACD 130 adjusts the maximum concurrency level of the agent 306 based on the correlation. In various embodiments, WFM system 310 provides the adjusted maximum concurrency limit to ACD 130, and ACD 130 limits the number of concurrent written interactions the agent 306 may handle simultaneously.

In exemplary embodiments, ACD 130 adds the readability score of the first written interaction 302 to a record of the past readability scores, receives a second written interaction from a second customer, and determines whether to route the second written interaction to the agent 306 based on a readability score of the second written interaction and the adjusted maximum concurrency level of the agent 306.

A specific example of the method 400 will now be described in detail. The minimum concurrency level for an agent was 1 and the maximum concurrency level was 5. Both minimum and maximum concurrency levels can be determined by a user, such as a workforce supervisor, a workforce manager, or other personnel in charge of managing the workload of agents. In some embodiments, WFM system 310 determines the minimum and maximum concurrency level of an agent by assessing a test set of written interactions provided to the agent. The mean concurrency level was calculated to be 3 (1+5/2) and the concurrency standard deviation was calculated to be 1.15 (5−1/\sqrt{12}). A sample set of readability scores containing 1000 cases with 1000 scores (not reproduced here) randomly assigned between 10 and 90 was obtained. The mean readability score was determined to be 51.0, and the readability standard deviation was determined to be 23.0.

A readability score scale and a concurrency level scale were created as shown below.

TABLE 1
READABILITY SCORE SCALE

| μ − 3σ | μ − 2σ | u − σ | μ | μ + σ | μ + 2σ | μ + 3σ |
|---|---|---|---|---|---|---|
| −18.0 | 5.0 | 28.0 | 51.0 | 74.0 | 97.0 | 120.0 |

TABLE 2
CONCURRENCY LEVEL SCALE

| μ − 3σ | μ − 2σ | u − σ | μ | μ + σ | μ + 2σ | μ + 3σ |
|---|---|---|---|---|---|---|
| −0.464 | 0.690 | 1.845 | 3 | 4.2 | 5.3 | 6.5 |

In the above example, the concurrency limit (i.e., the maximum concurrency limit) was adjusted for the given agent under the following circumstances. If the next written interaction had a readability score between 97 and 120, the agent's concurrency limit would be 6. If the next written interaction had a readability score between 74 and 97, the agent's concurrency limit would be 5. If the next written interaction had a readability score between 51 and 74, the agent's concurrency limit would be 4. If the next written interaction had a readability score between 28 and 51, the agent's concurrency limit would be 3. If the next written interaction had a readability score below 28, the agent's concurrency limit would be 1. The concurrency limits were rounded down to the nearest positive integer. As can be seen, the higher the readability score of the next written interaction, the higher the agent's concurrency limit.

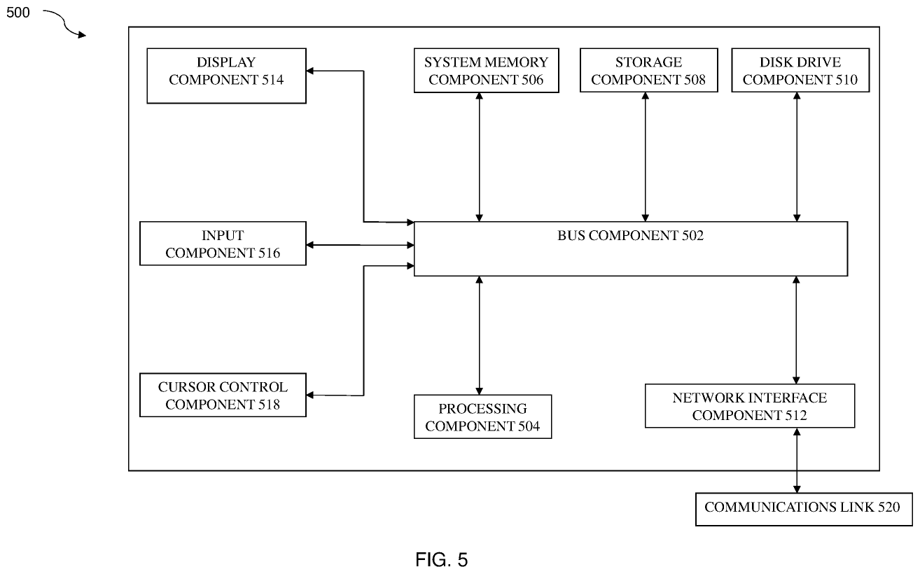

Referring now to FIG. 5, illustrated is a block diagram of a system 500 suitable for implementing embodiments of the present disclosure, including ACD 130 and WFM system 310. System 500, such as part a computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to receive a first written interaction from a first customer; route the first written interaction to an agent; determine a readability score of the first written interaction; aggregate the readability score with a plurality of past readability scores of written interactions assigned to the agent; create a readability score scale based on the aggregated readability score with the plurality of past readability scores; create a concurrency level scale based on a minimum concurrency level and a maximum concurrency level of the agent; correlate readability scores and concurrency levels using the readability score scale and the concurrency level scale; and adjust the maximum concurrency level of the agent based on the correlation. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., networks 102 or 104 of FIG. 2, LAN 132, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 520 and communication interface 512. Received program code may be executed by processor 504 as received and/or stored in disk drive component 510 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A workforce management system comprising:
a processor and a computer readable medium operably coupled thereto, the computer readable medium comprising a plurality of instructions stored in association therewith that are accessible to, and executable by, the processor, to perform operations which comprise:
receiving a first written interaction from a first customer;
routing the first written interaction to an agent;
determining a readability score of the first written interaction;
aggregating the readability score with a plurality of past readability scores of written interactions assigned to the agent;
creating a readability score scale based on the aggregated readability score with the plurality of past readability scores;
creating a concurrency level scale based on a minimum concurrency level and a maximum concurrency level of the agent;
correlating readability scores and concurrency levels using the readability score scale and the concurrency level scale; and
adjusting the maximum concurrency level of the agent based on the correlation.

2. The workforce management system of claim 1, wherein creating the readability score scale comprises calculating a mean readability score and one standard deviation from the mean readability score based on the aggregated readability score with the plurality of past readability scores.

3. The workforce management system of claim 2, wherein creating the readability score scale further comprises calculating two and three standard deviations of the readability score from the mean readability score.

4. The workforce management system of claim 1, wherein determining the readability score comprises:
calculating a Flesch reading ease score of the first written interaction;
classifying text of the first written interaction into a numeric class using a natural language processing algorithm; and
multiplying the Flesch reading ease score and the numeric class to provide the readability score of the first written interaction.

5. The workforce management system of claim 1, wherein the operations further comprise determining the minimum concurrency level and the maximum concurrency level of the agent.

6. The workforce management system of claim 1, wherein creating the concurrency level scale comprises calculating a mean concurrency level and one standard deviation from the mean concurrency level based on the minimum concurrency level and the maximum concurrency level.

7. The workforce management system of claim 6, wherein creating the concurrency level scale further comprises calculating two and three standard deviations of the concurrency level from the mean concurrency level.

8. The workforce management system of claim 1, wherein the operations further comprise:
determining a reading comprehension level of the agent; and
before routing the first written interaction to the agent, determining the agent is capable of handling the first written interaction based on the readability score of the first written interaction and the reading comprehension level of the agent.

9. The workforce management system of claim 1, wherein the operations further comprise:
adding the readability score of the first written interaction to a record of the past readability scores;
receiving a second written interaction from a second customer; and
determining whether to route the second written interaction to the agent based on a readability score of the second written interaction and the adjusted maximum concurrency level of the agent.

10. A method for managing the workload of an agent, which comprises:
receiving a first written interaction from a first customer;
routing the first written interaction to the agent;
determining a readability score of the first written interaction;
aggregating the readability score with a plurality of past readability scores of written interactions assigned to the agent;
creating a readability score scale based on the aggregated readability score with the plurality of past readability scores;
creating a concurrency level scale based on a minimum concurrency level and a maximum concurrency level of the agent;
correlating readability scores and concurrency levels using the readability score scale and the concurrency level scale; and
adjusting the maximum concurrency level of the agent based on the correlation.

11. The method of claim 10, wherein creating the readability score scale comprises calculating a mean readability score and one standard deviation from the mean readability score based on the aggregated readability score with the plurality of past readability scores.

12. The method of claim 10, wherein determining the readability score comprises:
calculating a Flesch reading ease score of the first written interaction;
classifying text of the first written interaction into a numeric class using a natural language processing algorithm; and
multiplying the Flesch reading ease score and the numeric class to provide the readability score of the first written interaction.

13. The method of claim 10, wherein creating the concurrency level scale comprises calculating a mean concurrency level and one standard deviation from the mean concurrency level based on the minimum concurrency level and the maximum concurrency level.

14. The method of claim 10, which further comprises:
determining a reading comprehension level of the agent; and
before routing the first written interaction to the agent, determining the agent is capable of handling the first written interaction based on the readability score of the first written interaction and the reading comprehension level of the agent.

15. The method of claim 10, which further comprises:
adding the readability score of the first written interaction to a record of the past readability scores;
receiving a second written interaction from a second customer; and
determining whether to route the second written interaction to the agent based on a readability score of the second written interaction and the adjusted maximum concurrency level of the agent.

16. A non-transitory computer-readable medium having stored thereon computer-readable instructions executable by a processor to perform operations which comprise:
receiving a first written interaction from a first customer;
routing the first written interaction to an agent;
determining a readability score of the first written interaction;
aggregating the readability score with a plurality of past readability scores of written interactions assigned to the agent;
creating a readability score scale based on the aggregated readability score with the past readability scores;
creating a concurrency level scale based on a minimum concurrency level and a maximum concurrency level of the agent;
correlating readability scores and concurrency levels using the readability score scale and the concurrency level scale; and
adjusting the maximum concurrency level of the agent based on the correlation.

17. The non-transitory computer-readable medium of claim 16, wherein creating the readability score scale comprises calculating a mean readability score and one standard deviation from the mean readability score based on the aggregated readability score with the past readability scores.

18. The non-transitory computer-readable medium of claim 17, wherein determining the readability score comprises:
calculating a Flesch reading ease score of the first written interaction;
classifying text of the first written interaction into a numeric class using a natural language processing algorithm; and
multiplying the Flesch reading ease score and the numeric class to provide the readability score of the first written interaction.

19. The non-transitory computer-readable medium of claim 16, wherein creating the concurrency level scale comprises calculating a mean concurrency level and one standard deviation from the mean concurrency level based on the minimum concurrency level and the maximum concurrency level.

20. The non-transitory computer-readable medium of claim 16, wherein the operations further comprise:
adding the readability score of the first written interaction to a record of the past readability scores;
receiving a second written interaction from a second customer; and
determining whether to route the second written interaction to the agent based on a readability score of the second written interaction and the adjusted maximum concurrency level of the agent.
